(19) United States
(12) Patent Application Publication
(10) Pub. No.: US 2018/0057684 A1
(43) Pub. Date: Mar. 1, 2018

(54) POLYESTER COMPOSITIONS

(71) Applicant: LANXESS DEUTSCHLAND GMBH, Cologne (DE)

(72) Inventors: BORIS NEUWALD, KOELN (DE); MATTHIAS BIENMUELLER, KREFELD (DE); JOACHIM MORICK, LEVERKUSEN (DE)

(73) Assignee: LANXESS DEUTSCHLAND GMBH, COLOGNE (DE)

(21) Appl. No.: 15/678,537

(22) Filed: Aug. 16, 2017

(30) Foreign Application Priority Data
Aug. 26, 2016 (EP) 16185856.8

(51) Int. Cl. C08L 67/02; C08L 25/12; C08K 7/14

(52) U.S. Cl. CPC C08L 67/02; C08L 25/12; B29K 2067/006; C08L 2205/02; C08K 7/14

(57) ABSTRACT

Hydrolysis-stable, reinforced compositions include polybutylene terephthalate, polyethylene terephthalate, styrene-acrylonitrile copolymer, and at least one aromatic epoxy compound. Laser-transparent articles of manufacture may be produced therefrom, and the compositions may be used in laser transmission welding.

The invention relates to novel, reinforced compositions based on polybutylene terephthalate, polyethylene terephthalate, styrene-acrylonitrile copolymer and at least one aromatic epoxy compound, to the use thereof for producing hydrolysis-stable, laser-transparent articles of manufacture, and to the use thereof in laser transmission welding.

### BACKGROUND INFORMATION

Fundamental principles of laser transmission welding are described in the technical literature (Kunststoffe 87, (1997) 3, 348-350; Kunststoffe 88, (1998), 2, 210-212; Kunststoffe 87 (1997) 11, 1632-1640; Plastverarbeiter 50 (1999) 4, 18-19; Plastverarbeiter 46 (1995) 9, 42-46).

Laser transmission welding is a single-stage process where the heating of the plastic and the joining operation proceed virtually simultaneously. One joining partner must have a high transmission coefficient and the other a high absorption coefficient in the range of the laser wavelength. Prior to the welding process the components to be welded are positioned in the desired end placement and the joining pressure is applied.

The transparent joining partner is irradiated by the laser beam without appreciable heating. Only in the second joining partner is the laser beam fully absorbed in a near-surface layer, thus converting the laser energy into heat energy and melting the plastic.

Owing to heat conduction processes the transparent component is also plasticized in the region of the joining zone. The externally applied joining pressure and the inner joining pressure resulting from the expansion of the plastics melt result in a cohesive joining of the components.

Customary laser sources employed in laser transmission welding are high performance diode lasers (HDL, λ=900-1100 nm) and solid-state lasers (fibre lasers), in particular Nd:YAG lasers, λ=1060-1090 nm since virtually all natural-coloured and unreinforced thermoplastics have a high transmission coefficient at this wavelength range which is an essential prerequisite of the transparent joining partner. The absorbing joining partner has absorbing pigments added to it which are usually carbon black pigments resulting in the black colour of these components to the human eye. However, so-called infrared absorbers, which can have a non-black colour in the visible wavelength range, also exist. See: (https://de.wikipedia.org/wiki/Laserdurchstrahlschwei%C3%9Fen).

Laser welding of semicrystalline thermoplastics is in principle more difficult than for amorphous products since the laser beam is scattered by the spherulites. This problem, encountered for all semicrystalline plastics, is particularly pronounced in polybutylene terephthalate (PBT): Compared to a polyamide 6 (PA6) sheet of identical thickness, PBT has a far lower laser transparency because the scattered fraction directed backwards is higher here on account of the pronounced scattering propensity. In addition, the beam passing through is spread/scattered to a greater extent.

Generally, and also in the context of the present invention, laser transparency (LT) is determined by photometric means at wavelengths in the range from 780 to 1100 nm. The experimental setup used in the experiments of the present invention was as follows: The radiation source was a halogen lamp which radiates a spectrum from visible light to near infrared. Below the light source the radiated light was focused by means of a pinhole aperture. The test sheet was positioned at a distance of 70 mm below the radiation source. The test sheets were injection moulded test sheets having dimensions of 60×40×2 mm³. The sheet was positioned such that the light beam is incident on/traverses the sheet in the centre (intersection of diagonals) with a radius of 5 mm. Two edge filters downstream of the test sheet were used to reduce the wavelength range of the traversed light spectrum to the range of 780 to 1100 nm. The radiation intensity of the filtered light was determined using a photodiode detector. The empty beam path was used as a 100% reference. Measurements were not carried out only at one wavelength but rather in a spectral range which encompasses all laser wavelengths currently employed for laser transmission welding operations in the range from 780 to 1100 nm.

An insufficient laser transparency can lead to increased cycle times in the laser welding operation, can result in defective parts, or can even render laser welding impossible. To a certain extent, the disadvantages may be compensated by increasing the welding time. However, for longer welding durations the probability of combustion or decomposition of the material increases.

If the average laser transparency is at a fairly low level, variations can have particularly negative consequences so that the welding operation can no longer be performed within an acceptable process window. This also results in damage. Since laser welding is normally the last step in a chain of production, defective parts at this point represent the loss of all value hitherto added.

Thus, various approaches for increasing the laser transparency (LT) of polyesters, in particular PBT, are known. One approach is mixing the low laser transparency PBT with a high laser transparency mixing partner. EP 2 949 703 A1, JP2004/315805A1 and DE-A1-10330722 disclose employing polyethylene terephthalate (PET) and optionally further additives in the form of phosphorus-comprising compounds or polycarbonate for this purpose.

US 2005/165176 A1 discloses the use of a styrene-acrylonitrile copolymer (SAN) for producing reinforced, laser-transparent polybutylene terephthalate-based articles of manufacture.

JP 2003 292752 A teaches the use of compositions of PBT and/or PET, SAN and glass fibres for producing reinforced, laser-transparent PBT-based articles of manufacture.

Finally, compositions comprising PBT, styrene-acrylonitrile copolymers and glass fibres are also known from EP 0 392 357 A2, DE 19929302 A1 and EP 1553138 A1.

A disadvantage of these prior art solutions is that while PET does have a positive effect on laser transparency, the further additions either reduce laser transparency or else impair the hydrolysis stability and/or the mechanical properties of articles of manufacture produced therefrom.

The problem addressed by the present invention is accordingly that of increasing laser transparency of reinforced articles of manufacture based on PBT/PET blends while retaining hydrolysis stability or even improving same without a reduction in mechanical characteristics, in particular in terms of flexural strength or impact resistance.

### SUMMARY

The solution to the problem and subject matter of the present invention are compositions and articles of manufacture producible therefrom comprising A) polybutylene terephthalate, B) polyethylene terephthalate, C) at least one styrene-acrylonitrile copolymer and D) at least one reinforcer.

A preferred solution to the problem and subject matter of the present invention are compositions and articles of manufacture producible therefrom comprising A) polybutylene terephthalate, B) polyethylene terephthalate, C) at least one styrene-acrylonitrile copolymer, D) at least one reinforcer and E) at least one aromatic epoxy compound, preferably an aromatic epoxy compound having 2 terminal epoxy functions.

Surprisingly, the addition of at least one styrene-acrylonitrile copolymer in combination with at least one hydrolysis stabilizer results in compositions according to the invention and articles of manufacture resulting therefrom which exhibit improved laser transparency but at the same time are hydrolysis-stable compared to the prior art, without disadvantages in mechanical characteristics being encountered.

The addition of at least one styrene-acrylonitrile copolymer to blends of PBT and PET allows laser welding of reinforced articles of manufacture which hitherto could not be subjected to laser welding owing to insufficient laser transparency. This makes applications available which were previously reserved to other joining processes. Alternatively, laser joining processes with reduced laser output may be used, thus increasing the lifetime of the laser to be employed and accordingly improving the economy of laser transmission welding processes.

The laser-transparent articles of manufacture made of compositions according to the invention further feature hydrolysis stability and an improved surface perception which manifests in higher gloss, a calmer/smoother surface and in a better colour perception.

### Definitions

It is a feature of reinforced compositions or articles of manufacture in the context of the present invention that they comprise at least one filler or reinforcer.

In the case of articles of manufacture producible according to the invention, good mechanical properties in the context of the present invention feature high values for izod impact resistance while maintaining high values for flexural modulus. Impact resistance describes the ability of a material of construction to absorb impact energy without fracturing. The testing of izod impact resistance to ISO 180 is a standard method for determining the impact resistance of materials. This involves first holding an arm of a pendulum impact tester at a particular height (=constant potential energy) and finally releasing it. The arm hits the sample, fracturing it. The impact energy is determined from the energy which is absorbed by the sample. Impact resistance is calculated as the ratio of impact energy to specimen cross section (unit of measurement: kJ/m²). In the context of the present invention, impact resistance was determined to ISO 180-1U at 23° C.

According to “http://de.wikipedia.org/wiki/Biegeversuch”, the flexural modulus is determined in the 3-point bending test by positioning a test specimen on two supports and loading it in the centre with a test ram. In the case of a flat sample, the flexural modulus is then calculated as follows:

$$E = \frac{{l}_{v}^{3} ( {X}_{H} - {X}_{L} )}{4 {D}_{L} {ba}^{3}}$$

wherein E=flexural modulus in kN/mm²; I_{Y}=distance between supports in mm; X_{H}=end of flexural modulus determination in kN; X_{L}=beginning of flexural modulus determination in kN; D_{L}=bending in mm between X_{H} and X_{L}; b=specimen width in mm; a=specimen thickness in mm. In the context of the present invention, flexural modulus was determined to ISO178-A at 23° C.

### DESCRIPTION OF THE EMBODIMENTS

The present invention preferably relates to compositions and laser-transparent articles of manufacture producible therefrom comprising:
A) polybutylene terephthalate,
B) polyethylene terephthalate,
C) at least one styrene-acrylonitrile copolymer,
D) at least one reinforce, and
E) at least one aromatic epoxy compound.

The present invention preferably relates to compositions and laser-transparent articles of manufacture producible therefrom comprising:
A) per 100 parts by mass of polybutylene terephthalate,
B) 0.5 to 34 parts by mass of polyethylene terephthalate,
C) 0.5 to 34 parts by mass of at least one styrene-acrylonitrile copolymer and
D) 10 to 200 parts by mass of at least one reinforce.

The present invention preferably relates to compositions and laser-transparent articles of manufacture producible therefrom comprising:
A) per 100 parts by mass of polybutylene terephthalate,
B) 5 to 15 parts by mass of polyethylene terephthalate,
C) 5 to 15 parts by mass of at least one styrene-acrylonitrile copolymer, and
D) 20 to 100 parts by mass of at least one reinforce.

The present invention preferably relates to compositions and laser-transparent articles of manufacture producible therefrom comprising:
A) per 100 parts by mass of polybutylene terephthalate,
B) 0.5 to 34 parts by mass of polyethylene terephthalate,
C) 0.5 to 34 parts by mass of at least one styrene-acrylonitrile copolymer,
D) 10 to 200 parts by mass of at least one reinforce, and
E) 0.01 to 30 parts by mass of at least one aromatic epoxy compound.

The present invention preferably relates to compositions and laser-transparent articles of manufacture producible therefrom comprising:
A) per 100 parts by mass of polybutylene terephthalate,
B) 5 to 15 parts by mass of polyethylene terephthalate,
C) 5 to 15 parts by mass of at least one styrene-acrylonitrile copolymer,
D) 20 to 100 parts by mass of at least one reinforce, and
E) 2 to 15 parts by mass of at least one aromatic epoxy compound.

The present invention also relates to the use of at least one styrene-acrylonitrile copolymer and an aromatic epoxy compound, preferably in combination with PET, particularly preferably in the form of a composition according to the invention, for producing hydrolysis-stable, reinforced, laser-transparent polybutylene terephthalate-based articles of manufacture.

The invention further relates to a laser welding process for joining at least two components of which at least one component comprises the composition according to the invention.

The invention further relates to the use of compositions comprising A) PBT, B) PET, C) at least one styrene-acrylonitrile copolymer, D) at least one reinforcer and E) at least one aromatic epoxy compound for producing hydrolysis-stable, laser-transparent articles of manufacture.

The invention further relates to a process for enhancing laser transparency of hydrolysis-stable, reinforced PBT- and PET-based articles of manufacture comprising at least one aromatic epoxy compound by addition of at least one styrene-acrylonitrile copolymer to the moulding materials provided for processing.

For clarity, it should be noted that the scope of the present invention encompasses al the definitions and parameters mentioned hereinafter in general terms or specified within areas of preference, in any desired combinations. The present invention relates to the compositions according to the invention, to moulding materials producible therefrom, and in turn to articles of manufacture, including laser-welded articles of manufacture, producible from the moulding materials, of which at least one component comprises a composition according to the invention. Cited standards are to be understood as meaning the version in force on the filing date unless otherwise stated.

The preparation of compositions according to the invention for the production of moulding materials for further use for producing laser-transparent articles of manufacture, preferably by injection moulding, in extrusion or for blow moulding is effected by mixing the individual components in at least one mixing assembly, preferably a compounder, particularly preferably a co-rotating twin-screw extruder. This affords moulding materials as intermediate products. These moulding materials—also referred to as thermoplastic moulding materials—may either consist exclusively of components A), B), C), D) and E) or else may also comprise, in addition to components A), B), C), D) and E), further components, in particular A), B), C), D), E) and F).

### Component A)

Polybutylene terephthalate (PBT) [CAS No. 24968-12-5] for use as component A) in accordance with the invention is produced from terephthalic acid or the reactive derivatives thereof and butanediol by known methods (Kunststoff-Handbuch, Vol. VIII, p. 695 ff, Karl Hanser Verlag, Munich 1973).

The PBT for use as component A) preferably comprises at least 80 mol %, preferably at least 90 mol %, based on the dicarboxylic acid, of terephthalic acid radicals.

In one embodiment, the PBT to be used according to the invention as component A) can comprise not only terephthalic acid radicals but also up to 20 mol % of radicals of other aromatic dicarboxylic acids having from 8 to 14 carbon atoms or radicals of aliphatic dicarboxylic acids having from 4 to 12 carbon atoms, in particular radicals of phthalic acid, isophthalic acid, naphthalene-2,6-dicarboxylic acid, 4,4′-diphenyldcarboxylic acid, succinic acid, adipic acid, sebacic acid, azelaic acid, cyclohexanediacetic acid, cyclohexanedicarboxylic acid or 2,5-furanedicarboxylic acid.

In one embodiment, the PBT for use as component A) in accordance with the invention may comprise in addition to butanediol up to 20 mol % of other aiphatic diols having 3 to 12 carbon atoms or up to 20 mol % of cycloaliphatic diols having 6 to 21 carbon atoms, preferably radicals of propane-1,3-diol, 2-ethylpropane-1,3-diol, neopentyl glycol, pentane-1,5-diol, hexane-1,6-diol, 1,4-cyclohexanedimethanol, 3-methylpentane-2,4-diol, 2-methylpentane-2,4-diol, 2,2,4-trimethylpentane-1,3-diol, 2,2,4-trimethylpentane-1,5-diol, 2-ethylhexane-1,3-diol, 2,2-diethylpropane-1,3-diol, hexane-2,5-diol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(3-β-hydroxyethoxyphenyl)propane and 2,2-bis(4-hydroxypropoxyphenyl)propane.

PBT preferred for use as component A) has an intrinsic viscosity according to EN-ISO 1628/5 in the range from 40 to 170 cm³/g, particularly preferably in the range from 50 to 150 cm³/g, very particularly preferably in the range from 65 to 135 cm³/g, in each case measured in phenol/o-dichlorobenzene (1:1 parts by weight) at 25° C. in an Ubbelohde viscometer. The intrinsic viscosity iV, also referred to as Staudinger Index or limiting viscosity, is proportional, according to the Mark-Houwink equation, to the average molecular mass, and is the extrapolation of the viscosity number VN for the case of vanishing polymer concentrations. It can be estimated from series of measurements or through the use of suitable approximation methods (e.g. Billmeyer). The VN [ml/g] is obtained from the measurement of the solution viscosity in a capillary viscometer, for example an Ubbelohde viscometer. The solution viscosity is a measure of the average molecular weight of a plastic. The determination is effected on dissolved polymer, with various solvents (m-cresol, tetrachloroethane, phenol, 1,2-dichlorobenzene, etc.) and concentrations being used. The viscosity number VN makes it possible to monitor the processing and performance characteristics of plastics. Subjection of the polymer to thermal stress, ageing processes or the action of chemicals, weathering and light may be investigated by means of comparative measurements. In this connection see also: http://de.wikipedia.org/wiki/Viskosimetrie and “http://de.wikipeda.org/wik/Mark-Houwnk-Gleichung”.

The PBT for use as component A) in accordance with the invention may also be employed in admixture with other polymers. The production of PBT blends for use in accordance with the invention is effected by compounding. During such a compounding operation, customary additives, in particular mould release agents or elastomers, may additionally be added to the melt to improve the properties of the blends.

PBT for use in accordance with the invention may be obtained from Lanxess Deutschland GmbH, Cologne under the name Pocan® B 1300.

### Component B)

Polyethylene terephthalate (PET) [CAS No. 25038-59-9] is employed as component B). Various PET types be employed here which differ for example in their viscosity and/or the catalysts present therein. Various PET copolymers may likewise be used, wherein the PET has been modified with the following monomers or derivatives of the following monomers: Diethylene glycol, polyethylene glycol, cyctohexanedimethano (cis-, trans- or mixtures), 2,2,4,4-tetramethyl-1,3-cyclobutanediol, norbomane-2,3-dicarboxylic acid, isophthalic acid, t-butylisophthalic acid, monosodium 5-sulphoisophthalate, naphthalene dicarboxylic acid, hydroxybenzoic acid, adipic acid.

The proportions of such comonomers is generally not more than 5 parts by mass, preferably not more than 2 parts by mass, based on 100 parts by mass of B).

The employable PET types may contain the catalysts generally utilized for the production thereof. These encompass salts of Ca, Mg, Zr, Mn, Zn, Pb, Sb, Sn, Ge and Ti, for example oxides, alkoxides and/or salts derived from organic acids, for example acetates, oxalates, citrates and/or lactates and also glycolates and complex/chelate compounds of these metals and mixtures thereof. The residual metal content of these catalysts in the PET for use in accordance with the invention is preferably s 300 ppm, particularly preferably s 260 ppm.

The PET for use in accordance with the invention preferably has an intrinsic viscosity in the range from about 30 to 150 cm³/g, particularly preferably in the range from 40 to 130 cm³/g, especially preferably in the range from 50 to 100 cm³/g, in each case measured in phenol/o-dichlorobenzene (1:1 parts by weight) at 25° C. by means of an Ubbelohde viscometer according to ISO 1628.

PET for use in accordance with the invention may for example be obtained under the name LIGHTER™ C93 from Equipolymers, Schkopau, Germany.

Component C)

At least one styrene-acrylonitrile copolymer based on vinylaromatics (C.1) and vinylcyanides (C.2) is employed as component C).

It is preferable when 100 parts by mass of a copolymer C) comprise
(C.1) 50 to 99 parts by mass of vinylaromatics and/or ring-substituted vinylaromatics, and
(C.2) 1 to 50 parts by mass of vinylcyanides.

Preferred compounds (C.1) are styrene, α-methylstyrene, p-methylstyrene, p-chlorostyrene, and/or (C₁-C₈)-alkyl methacrylates, in particular methyl methacrylate, ethyl methacrylate.

Preferred vinylcyanides are unsaturated nitriles, in particular acrylonitrile or methacrylonitrile, and/or (C₁-C₈)-alkyl (meth)acrylates, in particular methyl methacrylate, n-butyl acrylate, t-butyl acrylate, and/or derivatives of unsaturated carboxylic acids.

Preferred derivatives of unsaturated carboxylic acids are anhydrides or imides thereof, in particular maleic anhydride or n-phenyl maleimide.

Particularly preferred monomers (C.1) are selected from at least one of the monomers styrene, α-methylstyrene and methyl methacrylate.

Preferred monomers (C.2) are selected from at least one of the monomers acrylonitrile, maleic anhydride and methyl methacrylate.

Very particularly preferred monomers are (C.1) styrene and (C.2) acrylonitrile. Especial preference is given to a styrene-acrylonitrile copolymer known as SAN and having CAS No. 9003-54-7 which is available from Styrolution GmbH, Frankfurt am Main.

### Component D)

It is preferable to employ glass fibres as component D). These preferably have a fibre diameter in the range from 7 to 18 μm, more preferably in the range from 9 to 15 μm, and are added in the form of continuous fibres or in the form of chopped or ground glass fibres.

According to “http://de.wikipedia.org/wiki/Faser-Kunststoff-Verbund”, distinction is made between a) chopped fibres, also known as short fibres, having a length in the range from 0.1 to 1 mm, b) long fibres having a length in the range from 1 to 50 mm and c) endless fibres having a length L >50 mm. Fibre lengths may be determined—including in the context of the present invention—for example by microfocus x-ray computed tomography (μ-CT); DGZfP annual conference 2007—lecture 47.

The fibres are preferably modified with a suitable size system or an adhesion promoter or adhesion promoter system, particularly preferably based on silane.

Very particularly preferred silane-based adhesion promoters for pretreatment are silane compounds of general formula (I)

(X—(CH₂)_{q})ₖ—Si—(O—CᵣH₂ᵣ₊₁)₄₋ₖ (I)

in which the substituents are defined as follows:
X: NH₂—, HO—,

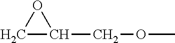

q: an integer from 2 to 10, preferably from 3 to 4,
r: an integer from 1 to 5, preferably from 1 to 2,
k: an integer from 1 to 3, preferably 1.

Especially preferred adhesion promoters are silane compounds from the group aminopropyltrimethoxysilane, aminobutyitrimethoxysilane, aminopropytIiethoxysilane, aminobutyltriethoxysilane and the corresponding silanes comprising a glycidyl group as the substituent X.

For modification of the glass fibres, the silane compounds are preferably used in amounts in the range from 0.05 to 2 parts by mass, particularly preferably in the range from 0.25 to 1.5 parts by mass and in particular in the range from 0.5 to 1 parts by mass based on 100 parts by mass of glass fibres for surface coating.

The glass fibres may as a result of the processing to afford the moulding material (compounding) or the article of manufacture producible therefrom have a lower d97 or d50 value in the moulding material or in the article of manufacture than the originally employed glass fibres. The glass fibres may as a result of the processing to afford the moulding material or the final article of manufacture have shorter length distributions in the moulding material or in the final article of manufacture than originally used.

### Component E)

Preferably employed hydrolysis stabilizers are epoxidized natural oils, epoxidized fatty acid esters or synthetic epoxidized compounds. These compounds preferably have at least one terminal epoxy group.

Preferred epoxidized natural oils are based on at least one oil from the group olive oil, linseed oil, coconut oil, peanut oil, palm oil, castor oil, soybean oil or cod liver oil. Particular preference is given to soybean oil.

The molecular weight of the epoxidized natural oils is preferably in the range from 500 to 1000 g/mol. Linseed or soybean oils preferred for use according to the invention are mixtures of triglycerides where the C₁₈-carboxylic acid content predominates.

Epoxidized natural oils are generally produced by methods familiar to those skilled in the art; see Angew. Chem. 2000, 112, 2292-2310.

Preferred epoxidized fatty acid esters are obtained from saturated or unsaturated aliphatic carboxylic acids having 10 to 40 carbon atoms, preferably 16 to 22 carbon atoms, by reaction with aliphatic saturated alcohols having 2 to 40 carbon atoms, preferably 2 to 6 carbon atoms.

It is preferable when mono- or dibasic carboxylic acids are concerned. It is particularly preferable to choose at least one carboxylic acid from the group pelargonic acid, palmitic acid, lauric acid, margaric acid, dodecanedloic acid, behenic acid, stearic acid, capric acid, montanic acid, linoleic acid, linolenic acid and oleic acid.

Preferred aliphatic saturated alcohols for use are mono- to tetrahydric. It is particularly preferable when at least one alcohol is selected from the group n-butanol, n-octanol, stearyl alcohol, ethylene glycol, propylene glycol, neopentyl glycol, pentaerythritol and glycerol. Glycerol is especially preferred.

Mixtures of different esters and/or oils may also be employed.

Introduction of the epoxy function into the abovementioned esters and/or oils is effected by reaction thereof with epoxidizing agents, preferably with peracids, in particular with peracetic acid. Such reactions are sufficiently well known to those skilled in the art.

The production of synthetic epoxidized compounds is likewise known to those skilled in the art. Synthetic oxidized compounds are:
polyglycidyl or poly(β-methylglycidyl) ethers obtainable by reaction of a compound having at least two free alcoholic or phenolic hydroxyl groups and/or by reaction of phenolic hydroxyl groups with a suitably substituted epichlorohydrin preferably under alkaline conditions or in the presence of an acidic catalyst and subsequent alkali treatment.

Preferred polyglycidyl or poly(β-methylglycidyl) ethers derive from acyclic alcohols, in particular ethylene glycol, diethylene glycol and higher poly(oxyethylene) glycols, propane-1,2-diol or poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylpropane, bistrimethylolpropane, pentaerythritol, sorbitol, or from polyepichlorohydrins.

Alternatively preferred polyglycidyl or poly(β-methylglycidyl) ethers derive from cycloaliphatic alcohols, in particular 1,3- or 1,4-dihydroxycyclohexane, bis(4-hydroxycyclohexyl)methane, 2,2-bis(4-hydroxycyclohexyl)propane or 1,1-bis(hydroxymethyl)cydohex-3-ene, or they comprise aromatic nuclei such as N,N-bis(2-hydroxyethyl)aniline or p,p′-bis(2-hydroxyethylamino)diphenylmethane.

Preferred synthetic epoxidized compounds are based on mononuclear phenols, on polynuclear phenols or on condensation products of phenols with formaldehyde obtained under acid conditions.

Preferred mononuclear phenols are resorcinol or hydroquinone.

Preferred polynuclear phenols are bis(4-hydroxyphenyl)methane, 2,2-bis(4-hydroxyphenyl)propane, 2,2-bis(3,5-dibromo-4-hydroxyphenyl)propane or 4,4′-dihydroxydiphenylsulphone.

Preferred condensation products of phenols with formaldehyde are phenol novolacs.

Preferably employed aromatic epoxy compounds of component E) are components having 2 terminal epoxy functions.

The aromatic epoxy compound is preferably an oligomeric reaction product of bisphenol A with epichlorohydrin of formula (II)

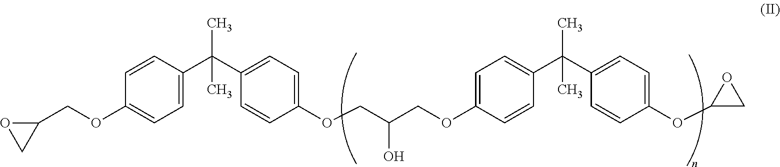

where n=0 to 10, preferably n=1 to 8, particularly preferably n=1 to 6 and n corresponds to the average number of units in the reaction product.

An aromatic epoxy compound for use according to the invention preferably has a softening point (Mettler, DIN 51920) in the range from 0° C. to 150° C., particularly preferably 50° C. to 120° C., very particularly preferably in the range from 60° C. to 110° C. and especially in the range from 75° C. to 95° C.

Aromatic epoxy compounds to be used with preference have an epoxy equivalent weight (EEW; DIN16945) in the range from 160 to 2000 g/eq, preferably 250 to 1200 g/eq, particularly preferably in the range from 350 to 1000 g/eq and especially preferably in the range from 450 to 800 g/eq.

It is especially preferable to employ as component E) a poly(bisphenol-A-co-epichlorohydrin) [CAS No. 25068-38-6], MW about 600 to 1800 g/mol, obtainable under the name Epilox® from Leuna Harze GmbH, Leuna.

### Component F)

In one embodiment the compositions according to the invention may also comprise in addition to components A) to E) at least one additive F) distinct from components C), D) and E) and selected from the group of phosphite stabilizers, mould release agents, UV stabilizers, heat stabilizers, gamma ray stabilizers, antistats, flow assistants, flame retardants, elastomer modifiers, fire retardant additives, emulsifiers, nucleation agents, plasticizers, lubricants, dyes and pigments, with the proviso that this additive does not substantially reduce laser transparency in the wavelength range in the range from 780 to 1200 nm.

It is preferable when per 100 parts by mass of component A) 0.1 to 100 parts by mass, particularly preferably 0.3 to 20 parts by mass, of component F) are employed. It is especially preferred when the moulding material according to the invention comprises no further constituents in addition to components A) to F).

An additive for use as component F) preferably has a particle size of s 1000 nm as a result of which it does dissolve in the polymer matrix of the PBT but does not lead to additional scattering of the laser radiation. Conversely, components immiscible in the polymer matrix and having a refractive index which differs greatly from that of PBT can result in scattering of the laser radiation. These and further suitable additives are described, for example, in Gächter, Müller, Kunstatoff-Additive [Plastics Additives], 3rd edition, Hanser-Verlag, Munich, Vienna, 1989 and in the Plastics Additives Handbook, 5th Edition, Hanser-Verlag, Munich, 2001. The additives for use as component F) may also be used alone or in admixture/in the form of masterbatches.

It is preferable when at least one phosphite stabilizer is used as component F). It is preferable to employ at least one phosphite stabilizer from the series tris(2,4-di-tert-butylphenyl) phosphite (Irgafos® 168, BASF SE, CAS No. 31570-04-4), bis(2,4-di-tert-butylphenyl)pentaerythrityl diphosphite (Ultranox® 626, Chemtura, CAS No. 26741-53-7), bis(2,6-di-tert-butyl-4-methylphenyl)pentaerythrity diphosphite (ADK Stab PEP-36, Adeka, CAS No. 80693-00-1), bis(2,4-dicumylphenyl)pentaerythrityl diphosphite (Doverpho® S-9228, Dover Chemical Corporation, CAS No. 154862-43-8), tris(nonylphenyl) phosphite (Irgafos® TNPP, BASF SE, CAS No. 26523-78-4), (2,4,6-tri-t-butylphenol)-2-butyl-2-ethyl-1,3-propanediol phosphite (Ultranox® 641, Chemtura, CAS No. 161717-324) or Hostanox® P-EPQ.

It is preferable when at least one mould release agent is used as component F). As preferred mould release agents, at least one is selected from the group of ester wax(es), pentaerythritol tetrastearate (PETS), long-chain fatty acids, salt(s) of the long-chain fatty acids, amide derivative(s) of the long-chain fatty acids, montan waxes and low molecular weight polyethylene or polypropylene wax(es), or ethylene homopolymer wax(es).

Preferred long-chain fatty acids are stearic acid or behenic acid. Preferred salts of long-chain fatty acids are calcium stearate or zinc stearate. A preferred amide derivative of long-chain fatty acids is ethylenebisstearylamide. Preferred montan waxes are mixtures of straight-chain saturated carboxylic acids having chain lengths of 28 to 32 carbon atoms.

Preferably employed heat or UV stabilizers are sterically hindered phenols, hydroquinones, aromatic secondary amines such as diphenylamines, substituted resorcinols, salicylates, benzotriazoles and benzophenones, and also variously substituted representatives of these groups or mixtures thereof.

Preferably employed plasticizers are dioctyl phthalate, dibenzyl phthalate, butyl benzyl phthalate, hydrocarbon oils or N-(n-butyl)benzenesulphonamide.

According to the invention elastomer modifiers may be employed as further components F). It is preferable to employ one or more graft polymers.

Graft polymers for use as elastomer modifiers are based on suitable graft substrates, preferably diene rubbers, EP(D)M rubbers, i.e. those based on ethylene/propylene and optionally diene, acrylate, polyurethane, silicone, chloroprene and ethylene-vinyl acetate rubbers.

Particularly preferred elastomer modifiers are ABS polymers (emulsion, bulk and suspension ABS), as described for example in DE-A 2 035 390 or in DE-A 2 248 242 or in Ullmann, Enzyklopädie der Technischen Chemie, vol. 19 (1980), p. 280 if. The gel content of the graft substrate is at least 30 wt %, preferably at least 40 wt % (measured in toluene). ABS is to be understood as meaning acrylonitrile-butadiene-styrene copolymer [CAS No. 9003-56-9] and is a synthetic terpolymer formed from the three different monomer types acrylonitrile, 1,3-butadiene and styrene. It is an amorphous thermoplastic. The quantitative ratios may vary from 15-35% acrylonitrile, 5-30% butadiene and 40-60% styrene.

Elastomer modifiers/graft copolymers for use as component F) are produced by free-radical polymerization, for example by emulsion, suspension, solution or bulk polymerization, preferably by emulsion or bulk polymerization.

Particularly suitable graft rubbers also include ABS polymers, which are produced by redox initiation with an initiator system of organic hydroperoxide and ascorbic acid according to U.S. Pat. No. 4,937,285.

### Process

The preparation of compositions according to the invention for the production of moulding materials for further use in injection moulding or in extrusion is effected by mixing the individual components in at least one mixing assembly, preferably a compounder. To produce a laser-transparent article of manufacture the moulding materials are subjected to further processing, preferably to an injection moulding process or an extrusion. The processes of injection moulding and of extrusion of thermoplastic moulding materials are known to those skilled in the art.

Inventive processes for producing laser-transparent articles of manufacture by extrusion or injection moulding are performed at melt temperatures in the range from 230° C. to 330° C., preferably from 250° C. to 300° C., and optionally also at pressures of not more than 2500 bar, preferably at pressures of not more than 2000 bar, particularly preferably at pressures of not more than 1500 bar and very particularly preferably at pressures of not more than 750 bar.

In extrusion it is preferable to distinguish between profile extrusion and sequential coextrusion. Sequential coextrusion involves extruding two different materials successively in alternating sequence. In this way, a preform having a different material composition section by section in the extrusion direction is formed. It is possible to provide particular article sections with specifically required properties through appropriate material selection, for example for articles with soft ends and a hard middle section or integrated soft bellows regions (Thielen, Hartwig, Gust, “Blasformen von Kunststoffhohlkörpern” [Blow-Moulding of Hollow Plastics Bodies], Carl Hanser Verlag, Munich 2006, pages 127-129).

The process of injection moulding features melting (plasticization) of the raw material, preferably in pellet form, in a heated cylindrical cavity, and injection thereof as an injection moulding material under pressure into a temperature-controlled cavity. After cooling (solidification) of the material, the injection moulding is demoulded.

The following operations are distinguished:
1. plasticization/melting
2. injection phase (filling operation)
3. hold pressure phase (because of thermal contraction during crystallization)
4. demoulding.

An injection moulding machine comprises a closure unit, the injection unit, the drive and the control system. The closure unit includes fixed and movable platens for the mould, an end platen, and tie bars and the drive for the movable mould clamping platen (toggle joint or hydraulic closure unit).

An injection unit comprises the electrically heatable barrel, the drive for the screw (motor, transmission) and the hydraulics for moving the screw and the injection unit. The injection unit serves to melt, meter, inject and exert hold pressure on (because of contraction) the powder/the pelletized material. The problem of melt backflow inside the screw (leakage flow) is solved by nonretum valves.

In the injection mould, the incoming melt is then separated and cooled and the article of manufacture to be fabricated is thus fabricated. Two halves of the mould are always required therefor. In injection moulding, the following functional systems are distinguished:
runner system
shaping inserts
venting
machine mounting and force absorption
demoulding system and motion transmission
temperature control
   In contrast to injection moulding, in extrusion an endless plastics extrudate, here made of an inventive moulding material, is employed in the extruder, the extruder being a machine for producing shaped thermoplastic mouldings. The following are distinguished:
single-screw extruder and twin-screw extruder and the respective sub-groups
conventional single-screw extruder, conveying single-screw extruder,
contra-rotating twin-screw extruder and co-rotating twin-screw extruder.

Extrusion plants comprise the elements extruder, mould, downstream equipment, extrusion blow moulds. Extrusion plants for producing profiles comprise the elements: extruder, profile mould, calibrating unit, cooling zone, caterpillar take-off and roller take-off, separating device and tilting chute.

Finally, the present invention relates to laser transmission welding processes with articles of manufacture obtained by extrusion, profile extrusion or injection moulding and based on compositions according to the invention.

The recited processes result in articles of manufacture which surprisingly have exceptional laser transparency in the wavelength range relevant for laser transmission welding processes from 780 to 1200 nm with mechanical properties that remain good. The laser-transparency-optimized articles of manufacture according to the invention may moreover be exceptionally stabilized against hydrolytic degradation by addition of appropriate hydrolysis stabilizers without undesired chain growth and associated processing problems or a reduction in laser weldability being encountered during processing.

In the context of the present invention laser transparency (LT) is measured/determined by photometric means over the entire wavelength range from 780 to 1100 nm as is more particularly elucidated in the example.

Inventive articles from the compositions according to the present invention can be applied to a laser transmission welding process. Preferred articles or by laser transmission welding process obtainable articles are materials for lids, housings, add-on parts, sensors. Articles of manufacture obtainable by laser transmission welding find application/are employed in particular in motor vehicles, in the electronics, telecommunication, information technology or computer industries and also in the household, sports, medical and entertainment sectors.

Preference in accordance with the invention is given to compositions and articles of manufacture producible therefrom comprising PBT, PET, SAN, glass fibre(s) and at least one aromatic epoxy compound.

Preference in accordance with the invention is given to compositions and articles of manufacture producible therefrom comprising PBT, PET, SAN, glass fibre(s) and at least one aromatic epoxy compound having 2 terminal epoxy functions.

Preference in accordance with the invention is given to compositions and articles of manufacture producible therefrom comprising PBT, PET, SAN, glass fibre(s) and at least one aromatic epoxy compound having 2 terminal epoxy functions of formula (II),

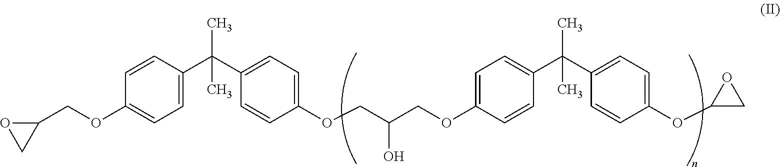

where n=0 to 10, preferably n=1 to 8, particularly preferably n=1 to 6 wherein n corresponds to the average number of units in the reaction product.

Preference in accordance with the invention is given to compositions and articles of manufacture producible therefrom comprising PBT, PET, SAN, glass fibre(s) and at least one aromatic epoxy compound having 2 terminal epoxy functions which has a softening point (Mettler, DIN 51920) in the range from 0° C. to 150° C., particularly preferably 50° C. to 120° C., very particularly preferably in the range from 60° C. to 110° C. and in particular in the range from 75° C. to 95° C.

Preference in accordance with the invention is given to compositions and articles of manufacture producible therefrom comprising PBT, PET, SAN, glass fibre(s) and at least one aromatic epoxy compound having 2 terminal epoxy functions having an epoxy equivalent weight (EEW; DIN16945) in the range from 160 to 2000 g/eq, preferably 250 to 1200 g/eq, particularly preferably in the range from 350 to 1000 g/eq and especially preferably in the range from 450 to 800 g/eq.

Preference in accordance with the invention is given to compositions and articles of manufacture producible therefrom comprising PBT, PET, SAN, glass fibre(s) and at least one bisphenol-A-based epoxy resin.

Preference according to the invention is given to compositions and articles of manufacture producible therefrom comprising PBT, PET, SAN, glass fibre(s) and at least poly(bisphenol-A-co-epichlorohydrin) [CAS No. 25068-38-6] having a MW in the range from 600 to 1800 g/mol.

It will be understood that the specification and examples are illustrative but not limitative of the present invention and that other embodiments within the spirit and scope of the invention will suggest themselves to those skilled in the art.

### Examples

To produce the compositions described in accordance with the invention, the individual components were mixed in the melt in a twin-screw extruder (ZSK 26 Mega Compounder from Coperion Werner & Pfieiderer, Stuttgart, Germany) at temperatures in the range from 285 to 310° C., extruded, cooled until pelletizable and pelletized. Before any further steps the pelletized material was dried at 120° C. in a vacuum drying cabinet for about 4 h.

The sheets and test specimens for the evaluations listed in Table 1 were injection moulded on a commercially available injection moulding machine at a melt temperature in the range from 250° C. to 270° C. and a mould temperature in the range from 80° C. to 100° C.

### Laser Transparency Measurement

Determination of laser transparency (LT) was effected by photometric means over the entire wavelength range from 780 to 1100 nm. The experimental setup was as follows: The radiation source was a halogen lamp which radiates a spectrum from visible light to near infrared. Below the light source the radiated light was focused by means of a pinhole aperture. The test sheet was positioned at a distance of 70 mm below the radiation source. The test sheets were injection moulded test sheets having dimensions of 60×40×2 mm³. The sheet was positioned such that the light beam is incident on/traverses the sheet in the centre (intersection of diagonals) with a radius of 5 mm. Two edge filters downstream of the test sheet were used to reduce the wavelength range of the traversed light spectrum to the range of 780 to 1100 nm. The radiation intensity of the filtered light was determined using a photodiode detector. The empty beam path was used as a 100% reference. In the examples and comparative examples reported in Table 1, “o” denotes adequate laser transparency with which an economic laser welding process may be accomplished up to a maximum wall thickness of 1.5 mm. In comparison, “−” denotes a transparency that is 25% lower and “−−” denotes a transparency that is 50% lower. A “+” in Table 1 denotes in terms of laser transparency measurement a value that is 25% higher than for “o”.

### Flexural Modulus and Flexural Strength

The flexural modulus (units of Pa) and flexural strength of the articles of manufacture produced from the inventive thermoplastic moulding materials were determined in a bending test according to ISO 178-A at 23° C. An alternative option for determination is provided by EN ISO 527 (http://de.wikipedla.org/wiki/EN_ISO_527-1). A flexural strength marked “o” is in Table 1 to be understood as meaning a flexural strength reduced by 10% compared to examples marked “+”.

### Impact Resistance

The impact resistance of the articles of manufacture produced from the inventive thermoplastic moulding materials in the form of test specimens having dimensions of 80×100×4 mm³ was determined in an impact test according to ISO 180-1U at 23° C. (units of kJ/m).

Impact Resistance after Hydrolysis

Articles of manufacture produced from the compositions according to the invention in the form of test specimens having dimensions of 80×100×4 mm³ were stored for 1000 hours in a constant climate cabinet (KMF240 from Binder, Tuttlingen, Germany) at 85° C. and 85% relative humidity. The Impact resistance of the stored articles of manufacture was then determined in an impact test according to ISO 180-1U at 23° C. (units of kJ/m²). In the examples and comparative examples reported in Table 1, “+” denotes a reduction in impact resistance after storage of less than 30% compared to the unstored sample. In comparison, “−” denotes an impact strength reduced by 50% and “−” an impact strength reduced by more than 60% compared to the associated unstored sample.

### Reactants

PBT: Polybutylene terephthalate having an intrinsic viscosity of 94 g/cm³ (Pocan® B1300, commercially available product from Lanxess Deutschland GmbH, Cologne)
PET: Polyethylene terephthalate having an intrinsic viscosity of 80 g/cm³ (LIGHTER™ C093, Equipolymers, Schkopau, Germany)
SAN: Styrene-acrylonitrile copolymer (Luran® SAN M 60, Ineos Styrolution, Frankfurt, Germany)
Glass fibres (GF): Glass fibres sized with silane-containing compounds and having a diameter of 10 μm (CS 7967, commercially available product from Lanxess N.V., Antwerp, Belgium)
Hydrolysis stabilizer: Oligomeric reaction product of bisphenol A and epichlorohydrin (see formula (I)), epoxy equivalent weight (DIN 16945) of 500 to 700 g/eq and softening point (Mettler, DIN 51920) between 75° C. and 90° C. [CAS No. 25068-38-6]
Further additives: In particular commercially available phosphite stabilizer and/or mould release agent: Licowax® E from Clariant International Ltd., Muttenz, Switzerland in an amount of 1.0 parts by mass based on 100 parts by mass of PBT for all examples.

It is apparent from Table 1 that, compared to articles of manufacture based on polymer compositions based exclusively on PBT as the only polymer component (comparator 1), or based on a mixture only of PBT and PET (comparator 2), articles of manufacture based on inventive compositions (examples 1 and 2) exhibit markedly better laser transmission values with mechanical properties that remain good. In addition, after climate storage the composition according to the invention (example 2) shows hydrolysis resistance that remains good and markedly improved laser transmission.

TABLE 1

| | Comp. 1 | Comp. 2 | Comp. 3 | Comp. 4 | Ex. 1 |
|---|---|---|---|---|---|
| Formulations | | | | | |
| PBT | 100 | 100 | 100 | 100 | 100 |
| PET | 0 | 76 | 0 | 8.4 | 8.7 |
| SAN | 0 | 0 | 0 | 8.4 | 8.7 |
| GF | 43 | 76 | 48 | 50 | 52 |
| Hydrolysis | 0 | 0 | 3.2 | 0 | 3.4 |
| stabilizer | | | | | |
| Test results | | | | | |
| LT | − | ∘ | −− | + | + |
| (780-1100 nm) | | | | | |
| Flexural strength | + | + | ∘ | + | + |
| IZOD impact | + | + | + | + | + |
| resistance | | | | | |
| IZOD impact | − | −− | + | − | + |
| resistance after | | | | | |
| 1000 hours at | | | | | |
| 85° C. and 85% | | | | | |
| rel. humidity | | | | | |

Reported amounts of components in Table 1 are in parts by mass in each case.

What is claimed is:

1. A composition comprising:
A) polybutylene terephthalate,
B) polyethylene terephthalate,
C) at least one styrene-acrylonitrile copolymer and
D) at least one reinforcer.

2. The composition according to claim 1, wherein, based on 100 parts by mass of A) polybutylene terephthalate, the composition comprises:
B) 0.5 to 34 parts by mass of the polyethylene terephthalate,
C) 0.5 to 34 parts by mass of the at least one styrene-acrylonitrile copolymer, and
D) 10 to 200 parts by mass of the at least one reinforcer.

3. The composition according to claim 1, further comprising E) at least one hydrolysis stabilizer.

4. The composition according to claim 3, wherein, based on A) 100 parts by mass of polybutylene terephthalate, the composition comprises 0.01 to 30 parts by mass of the at least one hydrolysis stabilizer.

5. The composition according to claim 1, wherein the at least one reinforcer D) comprises glass fibres.

6. The composition according to claim 1, wherein the at least one styrene-acrylonitrile copolymer C) comprises a copolymer based on vinylaromatics (C.1) and vinylcyanides (C.2).

7. The composition according to claim 6, wherein the copolymer C) comprises:
(C.1) 50 to 99 parts by mass of vinylaromatics and/or ring-substituted vinylaromatics, and
(C.2) 1 to 50 parts by mass of vinylcyanides,
based on 100 parts by mass of the copolymer C).

8. The composition according to claim 7, wherein the vinylaromatics and/or ring-substituted vinylaromatics comprise styrene, α-methylstyrene, p-methylstyrene, p-chlorostyrene, and/or (C₁-C₈)-alkyl methacrylates.

9. The composition according to claim 7, wherein the vinylcyanides comprise acrylonitrile or methacrylonitrile and/or (C₁-C₈)-alkyl (meth)acrylates and/or derivatives of unsaturated carboxylic acids.

10. The composition according to claim 7, wherein the vinylaromatics and/or ring-substituted vinylaromatics are selected from at least one of the monomers styrene, α-methylstyrene and methyl methacrylate.

11. The composition according to claim 7, wherein the vinylcyanides are selected from at least one of the monomers acrylonitrile, maleic anhydride and methyl methacrylate.

12. The composition according to claim 7, wherein the vinylaromatics and/or ring-substituted vinylaromatics comprise styrene and the vinylcyanides comprise acrylonitrile.

13. The composition according to claim 3, wherein the hydrolysis stabilizer comprises epoxidized natural oils, epoxidized fatty acid esters or synthetic epoxidized compounds.

14. The composition according to claim 4, wherein:
the at least one styrene-acrylonitrile copolymer C) comprises a copolymer based on vinylaromatics (C.1) and vinylcyanides (C.2);
the at least one reinforcer D) comprises glass fibres; and
the hydrolysis stabilizer comprises epoxidized natural oils, epoxidized fatty acid esters or synthetic epoxidized compounds.

15. The composition according to claim 14, wherein, based on 100 parts by mass of the copolymer C), the copolymer C) comprises:
(C.1) 50 to 99 parts by mass of vinylaromatics and/or ring-substituted vinylaromatics, and
(C.2) 1 to 50 parts by mass of vinylcyanides.

16. The composition according to claim 15, wherein the vinylaromatics and/or ring-substituted vinylaromatics comprise styrene and the vinylcyanides comprise acrylonitrile.

17. An article of manufacture comprising the composition according to claim 1.

18. The article of manufacture according to claim 14, wherein, based on 100 parts by mass of
A) polybutylene terephthalate, the composition comprises:
B) 0.5 to 34 parts by mass of the polyethylene terephthalate,
C) 0.5 to 34 parts by mass of the at least one styrene-acrylonitrile copolymer,
D) 10 to 200 parts by mass of the at least one reinforce, and
E) 0.01 to 30 parts by mass of at least one hydrolysis stabilizer

19. A method of producing reinforced, laser-transparent polybutylene-terephthalate-based articles of manufacture, the method comprising forming the reinforced, laser-transparent polybutylene-terephthalate-based articles of manufacture from the composition according to claim 1.

20. Laser welding process, wherein at least one of the components to be welded comprises the composition according to claim 1.
